(19) United States
(12) Patent Application Publication
(10) Pub. No.: US 2010/0188469 A1
(43) Pub. Date: Jul. 29, 2010

(54) RECORDING APPARATUS

(75) Inventor: Akihiko IKEGAMI, Okaya-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/689,883

(22) Filed: Jan. 19, 2010

(30) Foreign Application Priority Data
Jan. 29, 2009 (JP) 2009-018389

(51) Int. Cl. B41J 2/01

(52) U.S. Cl. 347/102

(57) ABSTRACT

A recording apparatus includes a plurality of recording heads that eject ink onto a recording medium to execute recording, a medium feeding unit that feeds the recording medium toward a downstream side of the recording apparatus in a feed direction, a heating/drying unit that heats the recorded recording medium to dry the ink on the recoding medium, and a cooling unit that is provided at the downstream side of the recording apparatus in the feed direction further down in comparison with the heating/drying unit and which cools the heated recording medium. The plurality of recording heads are provided in parallel with each other in the feed direction, and the heating/drying unit and the cooling unit are provided in the feed direction between one recording head at an upstream side and another recording head positioned adjacent to the downstream side of the one recording head.

### BACKGROUND

1. Technical Field

The present invention relates to a recording apparatus including a recording head for ejecting ink onto a recording medium to execute recording, a medium feeding unit for feeding the recording medium to a downstream side of the apparatus in a feed direction, and a heating/drying unit for heating and drying the ink recorded on the recording medium.

In this application, the recording apparatus includes an ink jet printer, a wire dot printer, a layer printer, a line printer, a duplicator, a facsimile, and the like.

2. Related Art

In general, a recording apparatus includes a recording head, a platen serving as a medium support, a pair of feeding rollers serving as a medium feeding unit, and a hot-air duct serving as a drying unit, as disclosed in JP-A-5-301340. Among the components, the recording head is provided to eject ink onto a sheet of paper to execute recording. The platen is provided opposite to the recording head to support the paper at a rear surface of the paper. Further, the hot-air duct is constructed to blow out hot air onto the recorded paper. Accordingly, it is possible to accelerate the drying of the ink on the recorded paper.

However, the hot-air duct serving as the drying unit is constructed to blow out only hot air onto the paper. In the case where the recording is executed with respect to the paper at a separate recording head located at a downstream side after drying, when the paper is transported to a position opposite to the recording head located at the downstream side, heat applied to the paper is also transferred together with the paper by the hot air. In this instance, there is concern that the heat is transferred to the recording head located at the downstream side, which may cause a defect. More specifically, there is concern that the ink remaining in nozzles of the recording head located at the downstream side may be dried by the heat to cause nozzle clogging. Also, there is concern that viscosity of the ink remaining in the nozzles may be increased by the heat to bring about defective ink ejection. In conclusion, productivity is deteriorated.

Further, since it is necessary to extend a transport path so as to lower the temperature of the paper to an original level spontaneously, it interferes with the downsizing of the recording apparatus.

### SUMMARY

An advantage of some aspects of the invention is to provide a recording apparatus capable of reducing an effect of heat with respect to a recording head located at a downstream side after a recording medium is heated, and also downsizing the apparatus.

According to a first aspect of the invention, there is provided a recording apparatus including a plurality of recording heads that eject ink onto a recording medium to execute recording, a medium feeding unit that feeds the recording medium toward a downstream side of the recording apparatus in a feed direction, a heating/drying unit that heats the recorded recording medium to dry the ink on the recoding medium, and a cooling unit that is provided at the downstream side of the recording apparatus in the feed direction in comparison with the heating/drying unit and cools the heated recording medium, in which the plurality of recording heads is provided in parallel with each other in the feed direction, and the heating/drying unit and the cooling unit are provided in the feed direction between one recording head at an upstream side and another recording head positioned adjacent to the downstream side of the one recording head.

According to the first aspect of the invention, the cooling unit can cool the recording medium heated by the heating/drying unit. As a result, it is possible to reduce the effect of the heat on the other recording head positioned at the downstream side to naught. That is, it is possible to prevent the heat of the heated recording medium from being transferred to the other recording head at the downstream side to cause a defect. More specifically, there is no concern that the ink remaining in nozzles of the recording head is dried by the heat to cause nozzle clogging. Also, there is no concern about defective ink ejection caused by the heat increasing viscosity of the ink remaining in the nozzles. In consequence, productivity can be enhanced.

Further, it is possible to prevent deterioration of the inner structure of the recording head. In the case of using an adhesive in the recording head, it is possible to prevent deterioration of the adhesive due to the heat.

In addition, the ink can be dried at high speed before the ink seeps in the recording medium immediately after recording. More specifically, by installing the cooling unit, a temperature of the heat (e.g., a temperature of the hot air) to heat the recording medium in the heating/drying unit can be raised, whatever a heatproof temperature of the recording head at the downstream side. Accordingly, if the heating temperature is raised, the ink can be dried quickly. As a result, an amount of deformation of the recording medium, such as wrinkling due to seeping of the ink, can be minimized. That is, it is possible to enhance the finish of the recording medium after recording. It is of particular value in the case where the recording medium is paper.

Further, as compared to the configuration in which the heated recording medium is cooled naturally, given that there is no need for a paper transport path to cool the paper naturally, the whole recording apparatus can be downsized.

According to a second aspect of the invention, in the recording apparatus according to the first aspect, the recording apparatus may further include a medium support unit that supports the recording heads and the recording medium and is positioned opposite to the recording medium, in which the cooling unit has a cold-air outlet port for blowing cold air of a temperature lower than an ambient temperature onto a surface of the recording medium, and a cooling member of a temperature lower than an ambient temperature, and the cooling member is provided in the medium support unit.

The term “ambient temperature” means a temperature at a normal state in a location where the recording apparatus is installed and heating or cooling is not carried out. Also, the term “surface of recording medium” means a surface on which the recording head ejects the ink.

According to the second aspect of the invention, the recording medium can be effectively cooled, in addition to the working effect of the first aspect. More specifically, since both front and rear surfaces of the heated recording medium can be cooled, the cooling efficiency is good as compared with the case in which either of the front or rear surfaces is cooled.

According to a third aspect of the invention, in the recording apparatus according to the first and second aspects, the heating/drying unit may have a hot-air outlet port for blowing hot air of a temperature higher than an ambient temperature onto the recording medium, the cooling unit may have a cold-air outlet port for blowing cold air of a temperature lower than the hot air onto the recording medium, a duct unit may be interposed between the one recording head at the upper stream side and the other recording head at the downstream side to guide air stream, the duct unit may be provided with the hot-air outlet port, an intake port for sucking air over the recording medium, and the cold-air outlet port in that order from the upstream side of the recording apparatus in the feed direction, and the intake port may suck in combination the air which is blown onto the recording medium from the hot-air outlet port and the cold-air outlet port.

According to the third aspect of the invention, the heating/drying unit and the cooling unit can be integrally downsized, in addition to the working effects of the first or second aspect. In consequence, the whole recording apparatus can be compact as compared with the non-integrated configuration.

The ink is cooled by the cold air immediately after it is heated by the hot air. At the same time, the hot air and the cold air blown onto the recording medium are exhausted through the intake port, thereby effectively carrying out dehumidification. That is, the space over the recording medium can be maintained in a dry state.

Further, since the air is exhausted through the intake port, there is less concern that the hot air and the cold air blown onto the recording medium in the feed direction to the one recording head at the upstream side and the other recording head at the downstream side which are disposed at the outside of the duct unit. In consequence, it is possible to reduce the effect resulting from flight of the ink when the ink is ejected onto the recording medium from the recording heads.

In addition, since the cold air possesses a property of “drying”, the ink on the recording medium can be also dried by the cold air, in addition to the hot air. That is, the configuration in which the cold air is blown onto the recording medium has a high drying capacitance as compared with the configuration in which the cold air is not blown onto the recording medium.

According to a fourth aspect of the invention, in the recording apparatus according to the third aspect, assuming that a hot-air supply volume blown out from the hot-air outlet port per unit of time is Q1, a cold-air supply volume blown out from the cold-air outlet port per unit of time is Q2, and an intake air volume sucked by the intake port is Q3, the following relationship may be satisfied.

intake air volume Q3≧hot-air supply volume Q1+cold-air supply volume Q2

According to the fourth aspect of the invention, in addition to the working effects of the third aspect, it is possible to prevent the air from leaking toward the recording head side. In consequence, it is possible to prevent the recording head from being damaged due to the air blown out from the duct unit. More specifically, it is possible to prevent the state of the ink in the nozzle from being changed.

Further, it is possible to reduce the effect on the flight of ink droplets ejected from the recording heads to naught. It is possible to prevent a so-called flight deflection due to the blown air.

According to a fifth aspect of the invention, in the recording apparatus according to the third or fourth aspects, assuming that wind speed when the hot air blown out from the hot-air outlet port reaches the recording medium is v1, and wind speed when the cold air blown out from the cold-outlet port reaches the recording medium is v2, the following relationship may be satisfied.

wind speed v1 of hot air≦wind speed v2 of cold air

According to the fifth aspect of the invention, it is possible to reduce concern that the ink in its liquid state is blown off before drying is completed, in addition to the working effects of the third or fourth aspect. More specifically, after the moisture of the ink is vaporized by relatively slowly with the hot air to increase the viscosity, the ink is cooled by contacting the ink with the cold ink at high speed, thereby reliably drying the ink of high viscosity.

According to a sixth aspect of the invention, in the recording apparatus according to one of the third to fifth aspects, the duct unit may include a hot-air duct that guides the hot air from a hot-air generating unit for generating the hot air to the hot-air outlet port, a cold-air duct that guides the cold air from a cold-air generating unit for generating the cold air to the cold-air outlet port, an exhaust duct that is provided adjacent to the cold-air duct and guides the exhaust air from the intake port to a suction generating unit, a condensing portion that is provided at the cold-air duct side in the exhaust duct and is made of a heat conductive material, at least a portion of the condensing portion being not provided with the heat insulation material, and a droplet collecting portion that is provided vertically under the condensing portion and receives droplets generated by the condensing portion.

According to the sixth aspect of the invention, it is possible to recover positively the moisture vaporized when the ink is dried, in addition to the working effects of any one of the third to fifth aspects.

According to a seventh aspect of the invention, in the recording apparatus according to any one of the third to sixth aspects, the recording apparatus may further include a medium support unit that supports the recording medium and is positioned opposite to the recording heads and the duct unit, a first shield member that is interposed between the one recording head at the upstream side and the heating/drying unit, a second shield member that is interposed between the other recording head at the downstream side and the cooling unit, a hot-air guide member that is provided at a position opposite to the medium support unit in the duct unit and guides the hot air from the hot-air outlet port to the intake port, and a cold-air guide member that is provided at a position opposite to the medium support unit in the duct unit and guides the cold air from the cold-air outlet port to the intake port. Assuming that a distance between the hot-air guide member and the medium support unit is g1, a distance between the cold-air guide member and the medium support unit is g2, and a distance between the first and second shield members and the medium support unit is g3, the following relationship may be satisfied.

g1>g3, g2>g3

According to the seventh aspect of the invention, it is possible reliably to prevent the air from leaking toward the recording head side, in addition to the working effects of any one of the third to sixth aspects.

According to an eighth aspect of the invention, in the recording apparatus according to the seventh aspect, at least one of the first shield member and the second shield member may be provided in plural, so that air stream formed by the hot air and the cold air blown onto the recording medium is exhausted between plural shield members.

According to the eighth aspect of the invention, it is possible reliably to prevent the air from leaking toward the recording head side, in addition to the working effects of the seventh aspect.

### BRIEF DESCRIPTION OF THE DRAWINGS

The invention will be described with reference to the accompanying drawings, wherein like numbers reference like elements

FIG. 1 is a side view schematically showing the whole configuration of a printer according to the invention.

FIG. 2 is a side view schematically showing a printer according to another embodiment 1 of the invention.

FIG. 3 is a side view schematically showing a printer according to another embodiment 2 of the invention.

FIG. 4 is a perspective view schematically showing a duct unit according to another embodiment 3 of the invention.

FIG. 5 is a perspective view schematically showing a duct unit according to another embodiment 4 of the invention.

### DESCRIPTION OF EXEMPLARY EMBODIMENTS

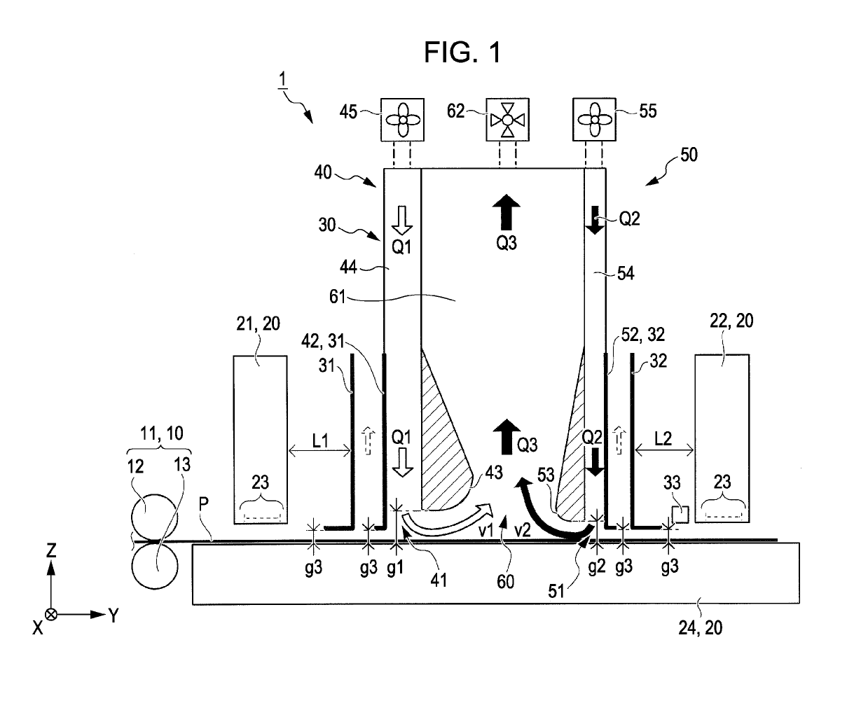

FIG. 1 shows a side view showing the whole configuration of an ink jet printer (hereinafter, simply referred to as a printer) 1 according to the invention which is an example of a recording apparatus or a liquid ejecting apparatus.

The liquid ejecting apparatus is not limited to a recording apparatus, such as an ink jet-type recording apparatus, a duplicator or facsimile, including a recording head serving as a liquid spraying head for spraying ink onto a recording material, such as recording paper, to execute recording, and by interpretation can comprise an apparatus including a liquid spraying head corresponding to the recording head for spraying a liquid responding to specific application, instead of the ink, onto a material to be sprayed corresponding to the recording material to fasten the liquid to the material to be sprayed.

Further, in addition to the above-described recording head, the liquid spraying head may be applied as a color material spraying head which can be employed to fabricate a color filter such as a liquid crystal monitor, an electrode material (conductive paste) spraying head which can be employed to form an electrode of an organic EL display, a surface emitting display (FED) or the like, a biological organic substance spraying head which can be employed to fabricate a biochip, a sample spraying head as a precision pipette for spraying a sample, and so forth.

As shown in FIG. 1, a printer 1 according to the invention includes a feeding unit 10, a recording unit 20, a heating/drying unit 40, and a cooling unit 50. Among the units, the feeding unit 10 is provided to feed a sheet of paper P to a downstream side (Y-axis direction) of the printer in a feed direction. More specifically, the feeding unit 10 includes, as one example, a pair of feed rollers 11 composed of a driving feed roller 12 and a driven feed roller 13, in which the driving feed roller 12 is driven by driving power of a motor (not shown) for driving the feeding unit. The driven feed roller 13 is constructed so as to be rotated by rotation of the driving feed roller 12.

Also, the feeding unit 10 may be a suction belt mechanism.

The suction belt mechanism is a mechanism including a belt wound around a plurality of rollers to feed the paper P. The suction belt mechanism is made up in such a way that the belt is provided with a plurality of holes, and a suction unit sucks the paper P via the holes formed in the belt, so that the paper P can be sucked to the belt and then is fed to the downstream side of the printer in a feed direction.

The recording unit 20 is provided to eject the ink onto the fed paper P to execute the recording. More specifically, the recording unit 20 includes a first recording head 21, a second recording head 22 provided at the downstream side of the printer in the feed direction further down in comparison with the first recording head 21, and a platen 24. The first recording head 21 and the second recording head 22 are extended over the whole area in a width direction (X-axis direction) of the paper P to eject the ink from a nozzle row 23. In this embodiment, the printer is constructed so as to complete the recording by ejection of the ink from the first recording head 21 and the second recording head 22. The platen 24 is provided to support the paper P at the rear surface of the paper P.

Further, the heating/drying unit 40 is constructed to interpose between the first recording head 21 and the second recording head 22 in a feed direction Y so as to heat the ink on the paper and thus accelerate the drying of the ink. In this embodiment, the hot air generated by a hot-air generating unit 45 is blown from a hot-air outlet port 41 via a hot-air supply duct 44 of the duct unit 30.

The hot-air generating unit may be made up of a heater and an air-stream generator. For example, a nichrome wire may be provided as the heater. The heat is generated from the nichrome wire itself by applying an electric current to the nichrome wire, so that the air can be heated by the heat. Also, a fan may be provided as the air-stream generator.

The paper P is heated by blowing the hot air onto the surface of the paper P to accelerate the drying of the ink on the paper, which is known as convection heating.

The term “convection” herein means transfer of heat through a flowing medium such as air or liquid.

The cooling unit 50 is constructed to interpose between the heating/drying unit 40 and the second recording head 22 in the feed direction Y so as to cool the paper P heated by the heating/drying unit 40 and the ink on the paper P. In this embodiment, the cold air generated by the cold-air generating unit 55 is blown from the cold-air outlet port 51 through a cold-air supply duct 54 of the duct unit 30.

The cold-air generating unit may be made up of a cooler and an air-stream generator. For example, a Peltier element may be used as the cooler. If an electric current is applied to the Peltier element, heat gradient is generated in the Peltier element, and thus the paper and the ink are cooled by the transfer of the heat.

Then, the cold air can be blown onto the surface of the paper P to cool the paper P and the ink on the paper. In addition, since the cold air possesses a drying property as compared to air of a temperature higher than a relationship of an amount of water vapor at saturation, it has an effect of accelerating the drying of the ink on the paper.

After that, the paper P is fed to the second recording head 22. As described above, the ink is ejected from the second recording head 22 to complete the recording.

At this time, the paper P and the ink on the paper P are cooled. Accordingly, it is possible to prevent the heat applied to the paper P by the heating/drying unit 40 from being transferred to the second recording head 22. As a result, nozzle clogging or defective ink ejection of the second recording head 22 due to the heat can be prevented. Further, the number of times that the printer 1 is stopped due to the defect of the second recording head 22 can be decreased thereby to improve the productivity.

Hereafter, the duct unit 30 and the periphery thereof will now be described in detail.

The duct unit 30 is interposed between the first recording head 21 and the second recording head 22 in the feed direction Y. The duct unit 30 includes a hot-air outlet port 41, an intake port 60, and a cold-air outlet port 51 in that order from an upstream side of the printer in the feed direction, at the side (under a Z-axis direction) opposite to the platen 24.

Meanwhile, the Z-axis direction is a direction in which the first recording head 21 opposites to the platen 24.

As described above, the hot air generated by the hot-air generating unit 45 is ejected from the hot-air outlet port 41 through the hot-air supply duct 44. Also, the cold-air generated by the cold-air generating unit 55 is ejected from the cold-air outlet port 51 through the cold-air supply duct 54.

Negative pressure is created in the inside of an exhaust duct 61 by a suction force of a suction generating unit 62, so that the intake port 60 can suck the air over the platen.

The suction generating unit may have a configuration capable of generating a suction force, such as a suction pump or a suction fan.

Therefore, after the hot air blown out from the hot-air outlet port 41 and the cold air blown out from the cold-air outlet port 51 are discharged onto the paper P, the hot air and the cold air are sucked by the intake port 60. In other words, the hot air and the cold air are exhausted from the space over the platen.

Meanwhile, the sucked air is discharged to another location (not shown).

Assuming that a hot-air supply volume blown out from the hot-air outlet port 41 per unit of time is Q1, a cold-air supply volume blown out from the cold-air outlet port 51 per unit of time is Q2, and an intake air volume sucked by the intake port 60 per unit of time is Q3, the following relationship is satisfied.

intake air volume Q3≧hot-air supply volume Q1+cold-air supply volume Q2

In consequence, it is possible to reduce concern that the hot air and the cold air are leaked out from the duct unit 30 toward the first recording head 21 side in the feed direction Y. In a similar way, it is possible to reduce concern that hot air and the cold air are leaked out from the duct unit 30 toward the second recording head 22 side in the feed direction Y.

Further, in the hot-air outlet port 41, the upstream side of the printer in the feed direction is formed by a first outer guide member 42. Meanwhile, the downstream side of the printer in the feed direction is formed by a hot-air guide member 43.

In a similar way, in the cold-air outlet port 51, the downstream side of the printer in the feed direction is formed by a second outer guide member 52, Meanwhile, the upstream side of the printer in the feed direction is formed by a cold-air guide member 53.

A front end of the hot-air guide member 43 and a front end of the cold-air guide member 53 are formed in a round shape. The reason is to increase a width of a flow path smoothly and quickly and also to decrease air pressure and wind speed smoothly and quickly. Accordingly, stream of the hot air blown into the cold-air outlet port 51 through the intake port 60 can be damped. In a similar way, a stream of the cold air blown into the hot-air outlet port 41 through the intake port 60 can be damped. In consequence, extreme turbulence is created in a space where the hot air collides with the cold air, which can reduce concern about adversely affecting a recorded image.

Assuming that wind speed when the hot air blown out from the hot-air outlet port 41 reaches the paper P is v1, and wind speed when the cold air blown out from the cold-outlet port 51 reaches the paper P is v2, the following relationship is satisfied.

wind speed v1 of hot airwind speed v2 of cold air

The wind speed v1 of the hot air may be equal to the wind speed v2 of the cold air, and the configuration in which the wind speed v1 of the hot air is slower than the wind speed v2 of the cold air is preferable.

In this instance, the hot air with slow wind speed can be gently blown onto the paper P, as compared with the cold air. In consequence, moisture contained in the ink ejected from the first recording head 21 may be vaporized by the hot air thereby to increase viscosity. At that time, it is possible to reduce the concern that the ink in its liquid phase is blown away before the ink on the paper is dried. After that, the ink can be cooled and completely dried by the cold air with relatively high wind speed. At that time, since the ink on the paper has high viscosity, there is no concern that the ink is blown away.

Further, Assuming that a distance between the hot-air guide member 43 and the platen 24 is g1, a distance between the cold-air guide member 53 and the platen 24 is g2, and a distance between the first outer guide member 42 and the platen 24 and a distance between the second outer guide member 52 and the platen 24 is g3, the following relationship is satisfied.

g1>g3, g2>g3

In consequence, it is possible to reduce the concern that the hot air is leaked out in the feed direction Y from the duct unit 30 toward the first recording head 21 side positioned at the upstream side. In a similar way, it is possible to reduce the concern that the cold air is leaked out in the feed direction Y from the duct unit 30 toward the second recording head 22 side positioned at the downstream side. In other words, it is possible to reduce the concern that the hot air and the cold air are leaked out in the feed direction Y from the duct unit 30.

In this embodiment, the distance g1 between the hot-air guide member 43 and the platen 24 is approximately 3.0 mm. The distance g2 between the cold-air guide member 53 and the platen 24 is approximately 2.0 mm. Further, the distance g3 between the first outer guide member 42 and the platen 24 and the distance g3 between the second outer guide member 52 and the platen 24 is approximately 1.0 mm.

The invention is not limited to the above distances.

A first shield plate 31 made of heat insulation material is interposed between the first recording head 21 and the duct unit 30 in the feed direction Y. A distance between the first shield plate 31 and the platen 24 is equal to the distance g3 between the first outer guide member 42 and the platen 24. Accordingly, it is possible to reduce the concern that the hot air and the cold air are leaked out in the feed direction Y from the duct unit 30 toward the first recording head 21 side positioned at the upstream side. Further, since the first shield plate 31 is made of the heat insulation material, it prevents the heat of the heating/drying unit 40 from being transferred by the first recording head 21.

In a similar way, a second shield plate 32 made of heat insulation material is interposed between the second recording head 22 and the duct unit 30 in the feed direction Y. A distance between the second shield plate 32 and the platen 24 is equal to the distance g3 between the second outer guide member 52 and the platen 24. Accordingly, it is possible to reduce the concern that the hot air and the cold air are leaked out in the feed direction Y from the duct unit 30 toward the second recording head 22 positioned at the downstream side.

Further, Assuming that a distance between the first shield plate 31 and the first recording head 21 in the feed direction Y is L1 and a distance between the second shield plate 32 and the second recording head 22 is L2, the following relationship is satisfied.

L1>L2

By relatively widening the distance L1, it prevents radiation heat by the hot air from reaching the first recording head 21 from the first outer guide member 42 which is heated. Meanwhile, the reason why the distance L2 is relatively narrowed is to be free of radiation heat and downsize the printer 1. In other words, the above relationship is eventually established by reducing the distance L2 as much as possible in order to downsize the printer.

Preferably, a plurality of first shield plates 31 is provided in consideration of the radiation heat generated from the first outer guide member 42.

In this embodiment, the reason why the distance between the first outer guide member 42 and the platen 24 is set to g3 is that the first outer guide member 42 also serves as the first shield plate 31. In the case where the first outer guide member 42 does not combine two functions, the distance between the first outer guide member 42 and the platen 24 may be set to be longer than g3. In order to downsize the printer, the first outer guide member 42 serves both as a guide member and a shield member an this embodiment. The second outer guide member 52 is provided in a similar way, and the description thereof will be omitted.

In addition, the air may be sucked by a suction unit (not shown) between the first outer guide member 42 and the first shield plate 31, and be discharged to another location (not shown). Of course, natural exhaust may be employed. In this instance, it is possible further to reduce the concern that the hot air and the cold air leaked out from the duct unit 30 reach the first recording head 21.

In the case where the plurality of first shield plates 31 is provided, the air may be sucked between the first shield plate 31 and the first shield plate 31, and be discharged to another location (not shown).

In a similar way, the air may be sucked by a suction unit (not shown) between the second outer guide member 52 and the second shield plate 32, and be discharged to other location (not shown). In this instance, it is possible further to reduce the concern that the hot air and the cold air leaked out from the duct unit 30 will reach the second recording head 22,

In the case where the plurality of second shield plates 32 is provided, the air is sucked between the second shield plate 32 and the second shield plate 32, and is discharged to other location (not shown).

A temperature sensor 33 interposed between the second shield plate 32 and the second recording head 22. A controller (not shown) may be provided to adjust the intensity of the cold air and/or the temperature of the cold air in response to a value of the temperature sensor 33.

For example, if the value of the temperature sensor 33 is higher than a first predetermined value, the controller judges that the cooling is not enough, and increases the air volume of the cold air until the value of the temperature sensor 33 reaches the first predetermined value. Also, the temperature of the cold air may be lowered by increasing the output of the cooler (not shown).

On the other hand, if the value of the temperature sensor 33 is lower than a second predetermined value, the controller judges that the cooling is more than enough, and decreases the air volume of the cold air until the value of the temperature sensor 33 reaches the second predetermined value. Also, the temperature of the cold air may be increased by lowering the output of the cooler (not shown). Herein, the second predetermined value is lower than the first predetermined value.

As a result, the printer can contribute to saving energy.

In this embodiment, the printer 1 is adapted to blow the hot air and the cold air from the integral duct unit 30 so as to downsize the printer 1, but the hot-air outlet port 41 and the cold-air outlet port 51 may be separately provided.

The printer 1 which is a recording apparatus according to the invention includes the first recording head 21 serving as a recording head for ejecting the ink onto the paper P which is one example of a recording medium to execute recording, the pair of feed rollers 11 serving as the feeding unit 10 which is a medium feeding unit for feeding the paper P towards the downstream side of the printer in the feed direction, the heating/drying unit 40 for heating the recorded paper to dry the ink on the recorded paper, and the cooling unit 50, provided at the downstream side of the printer in the feed direction further down in comparison with the heating/drying unit 40, for cooling the heated paper P.

Also, in the embodiment, as a recording head, the plurality of first recording heads 21 and the plurality of second recording heads 22 are provided in parallel with each other in the feed direction Y, and the heating/drying unit 40 and the cooling unit 50 are provided between the first recording head 21 serving as one recording head at the upstream side and the second recording head 22 serving as the other recording head positioned adjacent to the downstream side of the first recording head 21 in the feed direction.

Further, in the embodiment, the temperature sensor 33 serving as a temperature detecting unit is interposed between the cooling unit 50 and the second recording head 22 positioned at the downstream side in the feed direction Y to change the output of the cooling unit 50 in accordance with the temperature value which can be obtained by the temperature sensor 33.

In addition, in the embodiment, the heating/drying unit 40 has the hot-air outlet port 41 for blowing the hot air of a temperature higher than an ambient temperature onto the paper P, the cooling unit 50 has the cold-air outlet port 51 for blowing the cold air of a temperature lower than the hot air onto the paper P, the duct unit 30 is interposed between the first recording head 21 at the upper stream side and the second recording head 22 at the downstream side to guide air stream, the duct unit 30 is provided with the hot-air outlet port 41, the intake port 60 for sucking the air over the paper, and the cold-air outlet port 51 in that order from the upstream side of the printer in the feed direction, and the intake port 60 sucks in combination the air which is blown onto the paper from the hot-air outlet port 41 and the cold-air outlet port 51.

Still further, in the embodiment, assuming that a hot-air supply volume blown out from the hot-air outlet port 41 per unit of time is Q1, a cold-air supply volume blown out from the cold-air outlet port 51 per unit of time is Q2, and an intake air volume sucked by the intake port 60 is Q3, the following relationship is satisfied.

intake air volume Q3≧hot-air supply volume Q1+cold-air supply volume Q2

Still further, in the embodiment, assuming that wind speed when the hot air blown out from the hot-air outlet port 41 reaches the paper P is v1, and wind speed when the cold air blown out from the cold-outlet port 51 reaches the paper P is v2, the following relationship is satisfied.

wind speed v1 of hot air≦wind speed v2 of cold air

Still further, in the embodiment, the recording apparatus further includes the platen 24 serving as a medium support unit for supporting the paper P and positioned opposite the first recording head 21, the duct unit 30 and the second recording head 22, the first shield plate 31 interposed between the first recording head 21 at the upstream side and the heating/drying unit 40 and serving as a first shield member, the second shield plate 32 interposed between the second recording head 22 at the downstream side and the cooling unit 50 and serving as a second shield member, the hot-air guide member 43 provided at a position opposite the platen 24 in the duct unit 30 and guiding the hot air from the hot-air outlet port 41 to the intake port 60, and the cold-air guide member 53 provided at a position opposite the platen 24 in the duct unit 30 and guiding the cold air from the cold-air outlet port 51 to the intake port 60. Assuming that a distance between the hot-air guide member 43 and the platen 24 is g1, a distance between the cold-air guide member 53 and the platen 24 is g2, and a distance between the first shield plate 31 and the platen 24 and a distance between the second shield plate 32 and the platen 24 is g3, the following relationship is satisfied.

g1>g3, g2>g3

Still further, in the embodiment, at least one of the first shield plate 31 and the second shield plate 32 is provided in plural, so that the air stream formed by the hot air and the cold air blown onto the paper P is exhausted between the plural first shield plates 31 (or the second shield plates 32).

### Another Embodiment 1

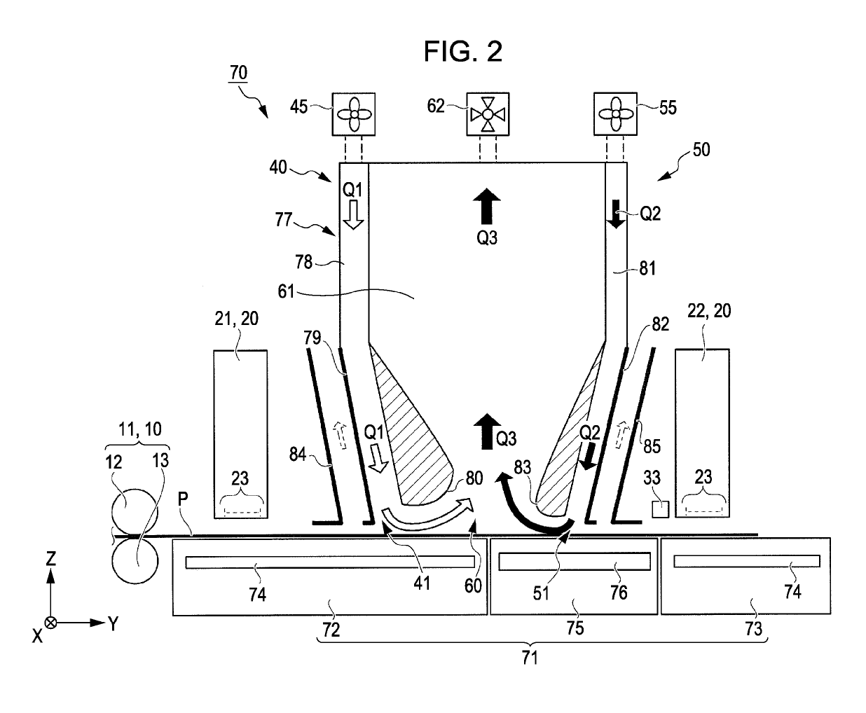

FIG. 2 is a side view schematically showing a printer according to anther embodiment 1.

As shown in FIG. 2, a platen 71 of a printer 70 according to another embodiment 1 includes a first heating platen 72, a cooling platen 75 and a second heating platen 73 in that order from an upstream side of the printer in a feed direction. Among the platens, the first heating platen 72 and the second heating platen 73 serve as the heating/drying unit 40. The cooling platen 75 serves as the cooling unit 50.

Except for components specifically described, other components are similar to those in the above-described embodiment, and thus the description thereof will be omitted.

The first heating platen 72 is extended from a position opposite to the first recording head 21 to a position opposite to the vicinity of a center portion of the intake port 60 of the duct unit 77 in the feed direction Y. The cooling platen 75 is extended from a position opposite to the vicinity of a center portion of the intake port 60 of the duct unit 77 to a position between the second shield plate 85 and the second recording head 22 in the feed direction Y. Also, the second heating platen 73 is extended from a position between the second shield plate 85 and the second recording head 22 to a position of the downstream side relative to the second recording head 22 in the feed direction Y.

The first heating platen 72 and the second heating platen 73 include a heater 74 made of, for example, a nichrome wire. The first heating platen 72 and the second heating platen 73 come in contact with a rear surface of the paper P at the surface thereof to heat the paper P, which is so-called heat conduction.

The term “heat conduction” means transfer of the heat from a hot portion to a cold portion through the inside of an object. That is, the heat is transferred to the paper by contacting the paper P with the first heating platen 72 and the second heating platen 73 which correspond to the hot object.

In addition to the heat to the front surface of the paper P by the hot air as described above, therefore, the rear surface of the paper P may be heated. In consequence, it is possible to accelerate the drying of the ink on the paper.

Also, the cooling platen 75 includes a cooling member 76 constituted by, for example a Peltier element. An upper surface of the cooling platen 75 may be cooled. Therefore, the cooling member 76 can deprive the paper P of the heat through the cooling platen 75, In consequence, in addition to the cooling to the front surface of the paper P by the cold air as described above, the rear surface of the paper P can be cooled. In other words, it is possible to effectively deprive the paper P of the heat and thus effectively cool the paper P.

In this another embodiment 1, the first heating platen 72 and the second heating platen 73 are provided, but only the cooling platen 75 may be provided, instead of the first heating platen 72 and the second heating platen 73.

The cooling platen 75 may include a cooling fan. The cooling member 76 provided in the cooling platen 75 may be cooled by the cooling fan, and the upper surface of the cooling platen 75 may come in contact with the rear surface of the paper P, thereby depriving the paper P of the heat. In other words, the cooling member 76 provided in the cooling platen 75 may be maintained at a temperature lower than the ambient temperature, thereby depriving the paper P of the heat through the cooling platen 75.

In the duct unit 77 according to another embodiment 1, the hot-air outlet port side of a hot-air supply duct 78 is inclined with respect to a Z-axis direction. More specifically, a first outer guide member 79 and a hot-air guide member 80 are inclined with respect to the Z-axis so as to displace toward the downstream side of the printer in the feed direction as the first outer guide member 79 and the hot-air guide member 80 extend to the downstream side in the direction in which the hot air flows. Accordingly, the hot air blown onto the paper P has a component of advancing toward the downstream side of the printer in the feed direction. In consequence, the hot air blown onto the paper P comes easily into the intake port 60, and thus it is possible to reduce the concern that the hot air is leaked out from the duct unit 77.

In a similar way, the cold-air outlet port side of a cold-air supply duct 81 is inclined with respect to the Z-axis direction. More specifically, a second outer guide member 82 and a cold-air guide member 83 are inclined with respect to the Z-axis so as to displace toward the upstream side of the printer in the feed direction as the second outer guide member 82 and the cold-air guide member 83 extend to the downstream side in the direction in which the cold air flows. Accordingly, the cold air blown onto the paper P has a component of advancing toward the upstream side of the printer in the feed direction. In consequence, the cold air blown onto the paper P comes easily into the intake port 60, and thus it is possible to reduce the concern that the cold air is leaked out from the duct unit 77.

Further, a first shield plate 84 is inclined with respect to the Z-axis, similar to the first outer guide member 79. Therefore, in the case where the hot air and the cold air are leaked out from the duct unit 77 toward the upstream side of the printer in the feed direction, the leaked hot air and the leaked cold air can be easily introduced between the first shield plate 84 and the first outer guide member 79. The leaked hot air and the leaked cold air can be sucked by the above-descried suction unit (not shown), and be discharged to another location (not shown). In consequence, it is possible further to reduce the concern that the hot air and the cold air leaked out from the duct unit 77 reach the first recording head 21.

In a similar way, a second shield plate 85 is inclined with respect to the Z-axis, similar to the second outer guide member 82. Therefore, in the case where the hot air and the cold air are leaked out from the duct unit 77 toward the downstream side of the printer in the feed direction, the leaked hot air and the leaked cold air can be easily introduced between the second shield plate 85 and the second outer guide member 82. The leaked hot air and the leaked cold air can be sucked by the above-described suction unit (not shown), and be discharged to another location (not shown). In consequence, it is possible further to reduce the concern that the hot air and the cold air leaked out from the duct unit 77 reach the second recording head 22.

The printer 70 according to another embodiment 1 includes the platen 71 serving as a medium support unit for supporting the paper P at the position opposite to the first recording head 21 and the second recording head 22, in which the cooling unit 50 includes the cold-air outlet port 51 for blowing the cold air of a temperature lower than an ambient temperature onto the paper P, and the cooling member 76 of temperature lower than the ambient temperature, and the cooling member 76 is provided in the cooling platen 75 constituting the platen 71.

### Another Embodiment 2

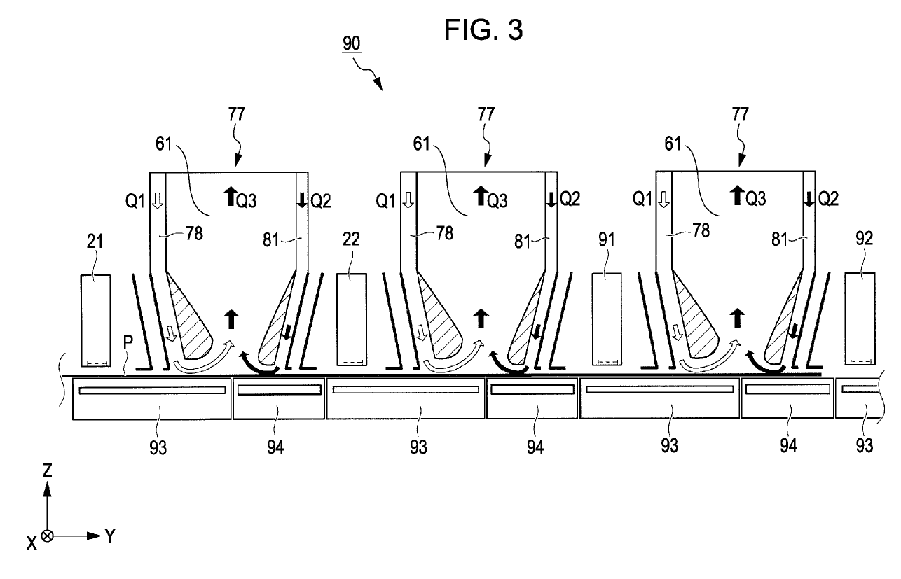

FIG. 3 is a side view schematically showing a printer according to another embodiment 2.

As shown in FIG. 3, a printer 90 according to another embodiment 2 includes a third recording head 91 and a fourth recording head 92 in addition to the first recording head 21 and the second recording head 22 of the above-described embodiment. Also, a heating platen 93 and a cooling platen 94 are alternatively arranged in a feed direction Y. Further, the duct unit 77 according to another embodiment 1 described above is provided between the first recording head 21 and the second recording head 22, between the second recording head 22 and the third recording head 91 and between the third recording head 91 and the fourth recording head 92.

Except for components specifically described, other components are similar to those in the above-described embodiment, and thus the description thereof will be omitted.

Therefore, similar to the working effects of the above-described embodiment, there is no concern that the heat applied to the paper P at the upstream side of the printer in the feed direction will affect the recording heads 22, 91 and 92 at the downstream side. In particular, it is effective the case of including the plurality of recording heads 21, 22, 91 and 92, as in the printer 90 of another embodiment 2.

The first recording heads 21 through the fourth recording head 92 may eject ink of different colors, respectively. For example, the first recording head 21 may eject cyan ink, the second recording head 22 may eject magenta ink, the third recording head 91 may eject yellow ink, and the fourth recording head 92 may eject black ink.

### Another Embodiment 3

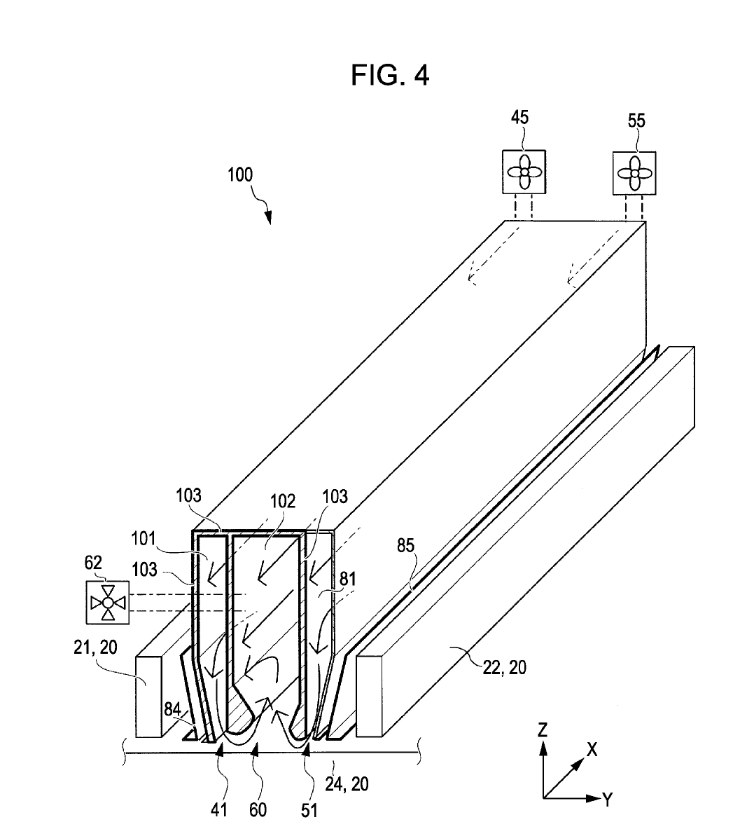

FIG. 4 is a perspective view schematically showing a duct unit according to another embodiment 3.

As shown in FIG. 4, a duct unit 100 according to another embodiment 3 includes a hot-air supply duct 101 and an exhaust duct 102 which are made of a heat insulation material 103.

Except for components specifically described, other components are similar to those in the above-described embodiment, and thus the description thereof will be omitted.

Accordingly, it is possible to prevent the heat of the hot air from transferring to the first recording head 21, the second recording head 22 and the cold-air supply duct 81. As a result, it can prevent the first recording head 21 and the second recording head 22 from being damaged due to the heat of the hot air. Also, it can prevent the cold air from being heated by the heat of the hot air in the cold-air supply duct 81. In other words, there is no concern that the cooling efficiency is deteriorated.

The hot air is supplied from the hot-air generating unit 45 provided at one end in a width direction X. The direction may be changed to the hot-air outlet port 41 by blade-shaped members (not shown) in the hot-air supply duct 101. The above configuration is applied in the same way to the cold air, and the description thereof will be omitted. Also, the air mixed with the hot air and the cold air sucked in the intake port 60 is upwardly sucked in the Z-axis direction in the exhaust duct 102, and the direction is changed to the other end side in the width direction X by the blade-shaped members in the exhaust duct 102. And, the air is sucked by the suction generating unit 62 provided at the other end side in the width direction X.

### Another Embodiment 4

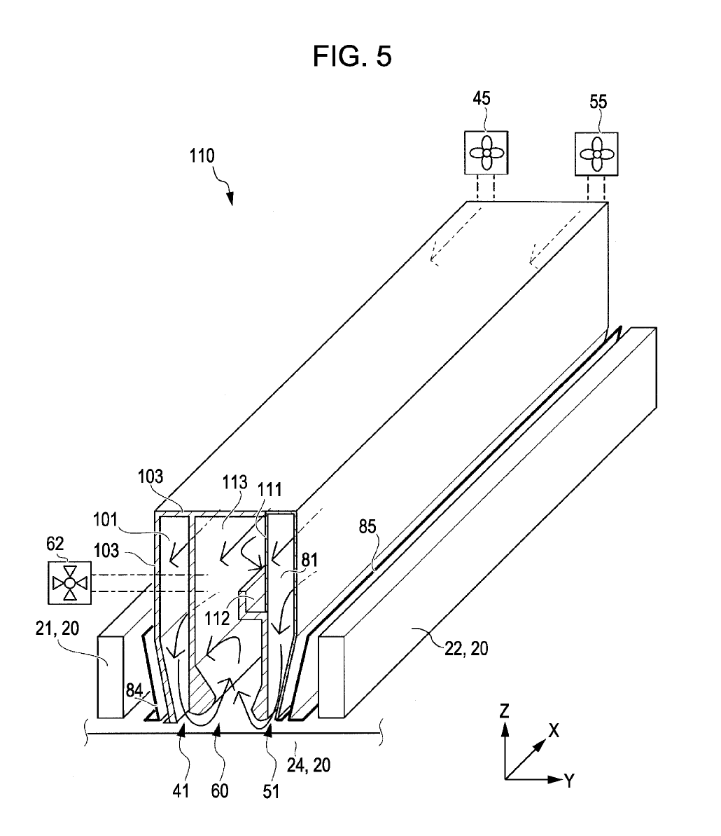

FIG. 5 is a perspective view schematically showing a duct unit according to another embodiment 4.

As shown in FIG. 5, a duct unit 110 according to another embodiment 4 includes a condensing portion 111 provided on a surface of the cold-air supply duct side, and a dew condensation water drainage groove 112 provided vertically under the condensing portion 111 in the exhaust duct 113.

Except for components specifically described, other components are similar to those in the above-described embodiment, and thus the description thereof will be omitted.

The condensing portion 111 is not made of the heat insulation material 103 at the cold-air supply duct side in the exhaust duct 113. In other words, the condensing portion 111 is made of a material of superior heat conductivity.

In the exhaust duct 113, except for the condensing portion 111, other portions are made of the heat insulation material 103, or are covered by the heat insulation material 103.

When the hot air blown out from the hot-air outlet port 41 and the cold air blown out from the cold-air outlet port 51 dry the ink on the paper, the hot air and the cold air absorb the moisture from the ink. The hot air and the cold air with a high water content are mixed to form mixed air, and then the mixed air flows into the exhaust duct 113. At that time, the heat around the condensing portion 111 is deprived by the cold air passing through the cold-air supply duct 81.

In other words, the condensing portion 111 is cooled. The moisture of the mixed air with a high water content which passes through the condensing portion 111 in the exhaust duct 113 is cooled by the condensing portion 111 so that condensation occurs. Therefore, the vaporized moisture contained in the ink is positively collected, thereby preventing the inside of the printer from being humid. In other words, dehumidification can be carried out.

Also, the dew condensation water drainage groove 112 receives condensed droplets dropping from the condensing portion 111. Further, the dew condensation water drainage groove 112 is constructed in such a way that one end side in the width direction X is lower than the other end side in the Z-axis direction. Therefore, after the dew condensation water drainage groove 112 receives the fallen droplets, the dew condensation water drainage groove 112 can collect the droplets in a droplet collecting tank (not shown) at the one end side.

It is preferable that the direction of the droplets flowing in the width direction X in the dew condensation water drainage groove 112 is same as that of the mixed air flowing in the width direction X in the exhaust duct 113, The reason is that the stream of the mixed air can promote the flow of the droplets in the inside of the dew condensation water drainage groove 112. More specifically, the dew condensation water drainage groove 112 is constructed in such a way that the other end provided with the suction generating unit 62 in the width direction X is inclined downward in the Z-axis direction rather than the one end side.

In another embodiment 4, the duct unit 110 includes the hot-air supply duct 101 serving as a hot-air duct for guiding the hot air from the hot-air generating unit 45 for generating the hot air to the hot-air outlet port 41, the cold-air supply duct 81 serving as a cold-air duct for guiding the cold air from the cold-air generating unit 55 for generating the cold air to the cold-air outlet port 51, the exhaust duct 113 provided adjacent to the cold-air supply duct 81 side and serving as an exhaust duct for guiding the exhaust air from the intake port 60 to the suction generating unit 62, the condensing portion 111 provided at the cold-air supply duct 81 in the exhaust duct 113 and made of a heat conductive material, at least a portion of the condensing portion being not provided with the heat insulation material 103, and the dew condensation water drainage groove 112 provided vertically under the condensing portion 111 and serving as a droplet collecting portion for receiving droplets generated by the condensing portion 111.

The invention is not limited to the above embodiments, and numerous modifications may be devised by those skilled in the art without departing from the scope of the following claims.

What is claimed is:

1. A recording apparatus comprising:
a plurality of recording heads that eject ink onto a recording medium to execute recording;
a medium feeding unit that feeds the recording medium toward a downstream side of the recording apparatus in a feed direction;
a heating/drying unit that heats the recorded recording medium to dry the ink on the recoding medium; and
a cooling unit that is provided at the downstream side of the recording apparatus in the feed direction further down in comparison with the heating/drying unit and which cools the heated recording medium,
wherein the plurality of recording heads are provided in parallel with each other in the feed direction, and
the heating/drying unit and the cooling unit are provided in the feed direction between one recording head at an upstream side and another recording head positioned adjacent to the downstream side of the one recording head.

2. The recording apparatus according to claim 1, further comprising:
a medium support unit that supports the recording medium and is positioned opposite to the recording heads,
the cooling unit having:
a cold-air outlet port for blowing cold air of a temperature lower than an ambient temperature onto a surface of the recording medium; and
a cooling member of a temperature lower than an ambient temperature,
wherein the cooling member is provided in the medium support unit.

3. The recording apparatus according to claim 1,
wherein the heating/drying unit has a hot-air outlet port for blowing hot air of a temperature higher than an ambient temperature onto the recording medium,
the cooling unit has a cold-air outlet port for blowing cold air of a temperature lower than the hot air onto the recording medium,
a duct unit is interposed between the one recording head at the upper stream side and the other recording head at the downstream side to guide air stream,
the duct unit is provided with the hot-air outlet port, an intake port for sucking air over the recording medium, and the cold-air outlet port in that order from the upstream side of the recording apparatus in the feed direction, and
the intake port sucks in combination the air which is blown onto the recording medium from the hot-air outlet port and the cold-air outlet port.

4. The recording apparatus according to claim 3, wherein assuming that a hot-air supply volume blown out from the hot-air outlet port per unit of time is Q1, a cold-air supply volume blown out from the cold-air outlet port per unit of time is Q2, and an intake air volume sucked by the intake port is Q3, the following relationship is satisfied.
intake air volume Q3≧hot-air supply volume Q1+cold-air supply volume Q2

5. The recording apparatus according to claim 3, wherein assuming that wind speed when the hot air blown out from the hot-air outlet port reaches the recording medium is v1, and wind speed when the cold air blown out from the cold-air outlet port reaches the recording medium is v2, the following relationship is satisfied.
wind speed v1 of hot air≦wind speed v2 of cold air

6. The recording apparatus according to claim 3, the duct unit comprising:
a hot-air duct that guides the hot air from a hot-air generating unit for generating the hot air to the hot-air outlet port;
a cold-air duct that guides the cold air from a cold-air generating unit for generating the cold air to the cold-air outlet port;
an exhaust duct that is provided adjacent to the cold-air duct and guides the exhaust air from the intake port to a suction generating unit;
a condensing portion that is provided at the cold-air duct side in the exhaust duct and is made of a heat conductive material, at least a portion of the condensing portion being not provided with the heat insulation material; and
a droplet collecting portion that is provided vertically under the condensing portion and receives droplets generated by the condensing portion.

7. The recording apparatus according to claim 3, further comprising:
a medium support unit that supports the recording medium and is positioned opposite to the recording heads and the duct unit;
a first shield member that is interposed between the one recording head at the upstream side and the heating/drying unit;
a second shield member that is interposed between the other recording head at the downstream side and the cooling unit;
a hot-air guide member that is provided at a position opposite to the medium support unit in the duct unit and guides the hot air from the hot-air outlet port to the intake port; and
a cold-air guide member that is provided at a position opposite to the medium support unit in the duct unit and guides the cold air from the cold-air outlet port to the intake port;
wherein assuming that a distance between the hot-air guide member and the medium support unit is g1, a distance between the cold-air guide member and the medium support unit is g2, and a distance between the first and second shield members and the medium support unit is g3, the following relationship is satisfied.
g1>g3, g2>g3

8. The recording apparatus according to claim 7, wherein at least one of the first shield member and the second shield member is provided in plural, so that air stream formed by the hot air and the cold air blown onto the recording medium is exhausted between plural shield members.
